(19) United States
(12) Patent Application Publication
(10) Pub. No.: US 2015/0278635 A1
(43) Pub. Date: Oct. 1, 2015

(54) METHODS AND APPARATUS FOR LEARNING REPRESENTATIONS

(71) Applicant: Massachusetts Institute of Technology, Cambridge, MA (US)

(72) Inventors: Tomaso Armando Poggio, Needham, MA (US); Joel Zaidspiner, Leibo (GB)

(73) Assignee: Massachusetts Institute of Technology, Cambridge, MA (US)

(21) Appl. No.: 14/231,503

(22) Filed: Mar. 31, 2014

(51) Int. Cl. G06K 9/62; G06K 9/52; G06K 9/00

(52) U.S. Cl. CPC G06K 9/627; G06K 9/00295; G06K 9/52

(57) ABSTRACT

Systems and methods for processing an input signal. In some embodiments, an input pattern in the input signal may be combined with each stored representation of a plurality of stored representations of at least one template to obtain a respective value for each stored representation, thereby obtaining a plurality of values. A representation for the input pattern may be constructed at least in part by analyzing a probability distribution associated with the plurality of values, and the representation for the input pattern may be provided to a recognizer programmed to process the representation for the input pattern and output at least one label for the representation for the input pattern. In some embodiments, the plurality of stored representations of the at least one template comprises a sequence of stored representations representing the at least one template undergoing a transformation that is not translation or scaling.

### BACKGROUND OF INVENTION

Machine learning systems process input signals and perform various tasks such as identifying known patterns, learning new patterns, categorizing, etc. For example, some machine learning systems have been developed to perform tasks that humans are naturally adapted to do, such as recognizing objects in an image and sounds in an audio segment. Machine learning systems have also been developed to process other types of input signals, such as seismic data, financial data, etc.

Some machine learning systems use supervised learning techniques, where a system receive as input both an data signal and a supervisory signal. A data signal may include an audio recording of human speech, an image of a human face, etc., while a corresponding supervisory signal may include, respectively, a transcript of the recorded speech, an identifier of the person depicted in the image, etc. A data signal thus accompanied by a supervisory signal is sometimes referred to as “labeled” training data.

### BRIEF SUMMARY OF INVENTION

In some embodiments, a computer-implemented method is provided for processing an input signal, the method comprising acts of: combining an input pattern in the input signal with each stored representation of a plurality of stored representations of at least one template to obtain a respective value for each stored representation, thereby obtaining a plurality of values; constructing a representation for the input pattern at least in part by analyzing a probability distribution associated with the plurality of values; and providing the representation for the input pattern to a recognizer programmed to process the representation for the input pattern and output at least one label for the representation for the input pattern. In some embodiments, at least one computer-readable storage medium is provided, having encoded thereon instructions that, when executed by at least one processor, cause the at least one processor to perform a method for processing an input signal, the method comprising acts of: combining an input pattern in the input signal with each stored representation of a plurality of stored representations of at least one template to obtain a respective value for each stored representation, thereby obtaining a plurality of values; constructing a representation for the input pattern at least in part by analyzing a probability distribution associated with the plurality of values; and providing the representation for the input pattern to a recognizer programmed to process the representation for the input pattern and output at least one label for the representation for the input pattern.

In some embodiments, a system is provided for processing an input signal, the system comprising at least one processor programmed by executable instructions to perform a method comprising acts of: combining an input pattern in the input signal with each stored representation of a plurality of stored representations of at least one template to obtain a respective value for each stored representation, thereby obtaining a plurality of values; constructing a representation for the input pattern at least in part by analyzing a probability distribution associated with the plurality of values; and providing the representation for the input pattern to a recognizer programmed to process the representation for the input pattern and output at least one label for the representation for the input pattern.

In some embodiments, a computer-implemented method is provided for processing an input signal, the method comprising acts of: combining an input pattern in the input signal with each stored representation of a plurality of stored representations of at least one template to obtain a respective value for each stored representation, thereby obtaining a plurality of values, wherein: the plurality of stored representations of the at least one template comprises a sequence of stored representations representing the at least one template undergoing a transformation that is not translation or scaling; constructing a representation for the input pattern based on the plurality of values; and providing the representation for the input pattern to a recognizer programmed to process the representation for the input pattern and output at least one label for the representation for the input pattern.

In some embodiments, at least one computer-readable storage medium is provided, having encoded thereon instructions that, when executed by at least one processor, cause the at least one processor to perform a method for processing an input signal, the method comprising acts of: combining an input pattern in the input signal with each stored representation of a plurality of stored representations of at least one template to obtain a respective value for each stored representation, thereby obtaining a plurality of values, wherein: the plurality of stored representations of the at least one template comprises a sequence of stored representations representing the at least one template undergoing a transformation that is not translation or scaling; constructing a representation for the input pattern based on the plurality of values; and providing the representation for the input pattern to a recognizer programmed to process the representation for the input pattern and output at least one label for the representation for the input pattern.

In some embodiments, a system is provided for processing an input signal, the system comprising at least one processor programmed by executable instructions to perform a method comprising acts of: combining an input pattern in the input signal with each stored representation of a plurality of stored representations of at least one template to obtain a respective value for each stored representation, thereby obtaining a plurality of values, wherein: the plurality of stored representations of the at least one template comprises a sequence of stored representations representing the at least one template undergoing a transformation that is not translation or scaling; constructing a representation for the input pattern based on the plurality of values; and providing the representation for the input pattern to a recognizer programmed to process the representation for the input pattern and output at least one label for the representation for the input pattern.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

FIG. 1 illustrates an example in which recognition is performed on “rectified” representations of input data, as well as raw input data, in accordance with some embodiments.

FIG. 2 illustrates an example of a data preprocessing module that processes raw data and outputs corresponding “rectified” representations, in accordance with some embodiments.

FIG. 3 illustrates an example of a system in which the rectified representations generated by a data preprocessing module are used to train a recognizer, or provided as input to the recognizer, in accordance with some embodiments.

FIG. 4 shows an illustrative example in which an input signal is processed to obtain a representation for an input pattern in the input signal, in accordance with some embodiments.

FIG. 5 shows an illustrative method for constructing a representation for an input pattern, in accordance with some embodiments.

FIG. 6A shows another illustrative example in which an input signal is processed to obtain a representation for an input pattern in the input signal, in accordance with some embodiments.

FIG. 6B shows another illustrative method for constructing a representation for an input pattern, in accordance with some embodiments.

FIG. 7 shows an illustrative hierarchical architecture built from Hubel-Wiesel modules, in accordance with some embodiments.

FIG. 8 shows empirical results that demonstrate the properties of invariance, stability and uniqueness of a hierarchical architecture, in accordance with some embodiments.

FIG. 9 shows an illustrative neuron that is capable of performing high-dimensional inner products between inputs on its dendritic tree and stored synapse weights.

FIG. 10 shows an illustrative implementation of a computer system that may be used in connection with some embodiments of the present disclosure.

### DETAILED DESCRIPTION OF INVENTION

Different types of labels may be provided depending on the task to be performed by a machine learning system. For example, if the task is to distinguish between male and female faces, the system may be trained using images that are labeled either “male” or “female.” By analyzing faces that are known to be male faces and those that are known to be female faces, the system may automatically learn the features that are useful in making this distinction (e.g., a feature the presence of which is correlated with the label “male” and/or the absence of which is correlated with the label “female”), and may use those distinguishing features to automatically categorize new faces as “male” or “female.”

As another example, if the task is to identify a person from an image, the system may be trained using images that are each labeled with the name, or some other suitable identifier, of the person depicted. The system may analyze a training image and store one or more features of the depicted face in association with the corresponding name or identifier. Upon receiving a new image, the system may identify one or more features of the face depicted in the new image and search the stored information for known faces that match one or more of the identified features.

In addition to, or instead of, supervised learning techniques, some machine learning systems use unsupervised or semi-supervised learning techniques. For example, a system may be trained using unlabeled data only, or a combination of labeled and unlabeled data.

The inventors have recognized and appreciated that the accuracy and/or efficiency of a machine learning system may depend on the particular way in which input data is represented in the system. For example, representations that are invariant to certain transformations may significantly simplify recognition tasks such as categorization and identification.

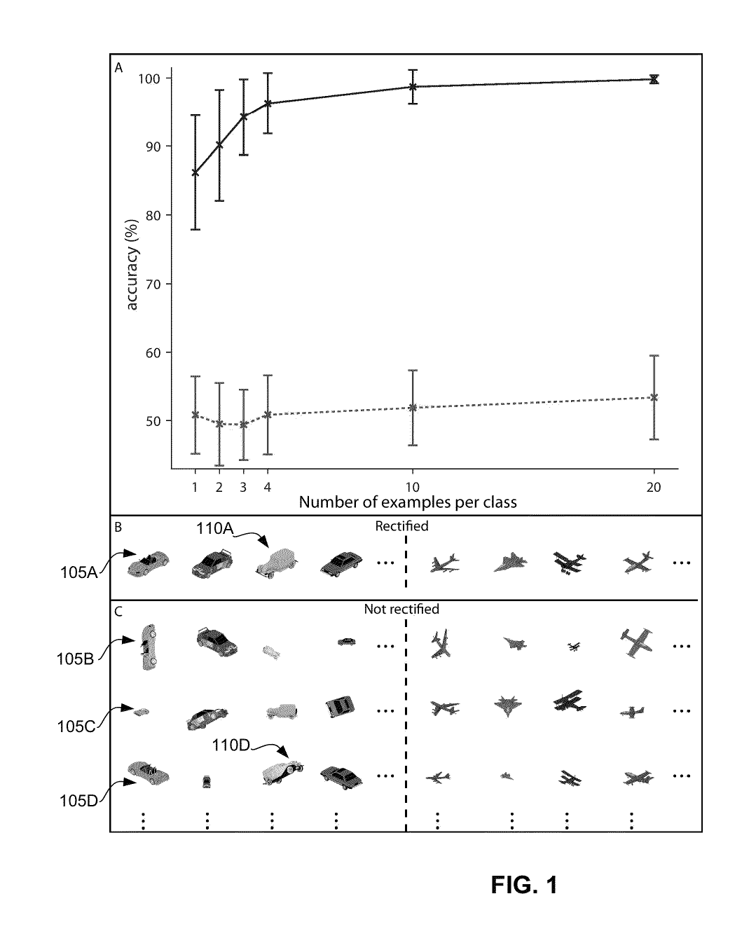

FIG. 1 illustrates an example in which both accuracy and efficiency are improved by performing recognition on “rectified” representations of input data, as opposed to raw input data, in accordance with some embodiments. In this example, two different experiments are run in which a recognizer is trained to tell cars and airplanes apart. In the first experiment, the recognizer is trained and tested using rectified representations of cars and airplanes, while in the second experiment, the recognizer is trained and tested using raw images of cars and airplanes.

In the example of FIG. 1, multiple raw images of the same object (car or airplane) are included in the training set in the second experiment. For instance, images 105B-D shown in the left-most column in the bottom portion of FIG. 1 may be images of the same car. These images may be related to each other by certain transformations. For example, the image 105D may be the result of performing a series of rotations on the image 105B. The rotations may include a rotation in the two-dimensional (2D) image plane and/or a rotation in another plane in the three-dimensional (3D) space. As another example, the image 105C may the result of performing a series of rotations on the image 105B, followed by a scaling operation.

The inventors have recognized and appreciated that variations such as those present in the images 105B-D may not be relevant for the task at hand—telling cars and airplanes apart. Therefore, their presence in the training data may not improve the recognizer's performance. To the contrary, their presence may negatively impact performance by “distracting” the recognizer with irrelevant information. For example, the presence of these variations may make it harder for the recognizer to identify features that are common among all cars. Therefore, it may be beneficial to factor out these variations from both the training data and the input data on which the recognizer is run.

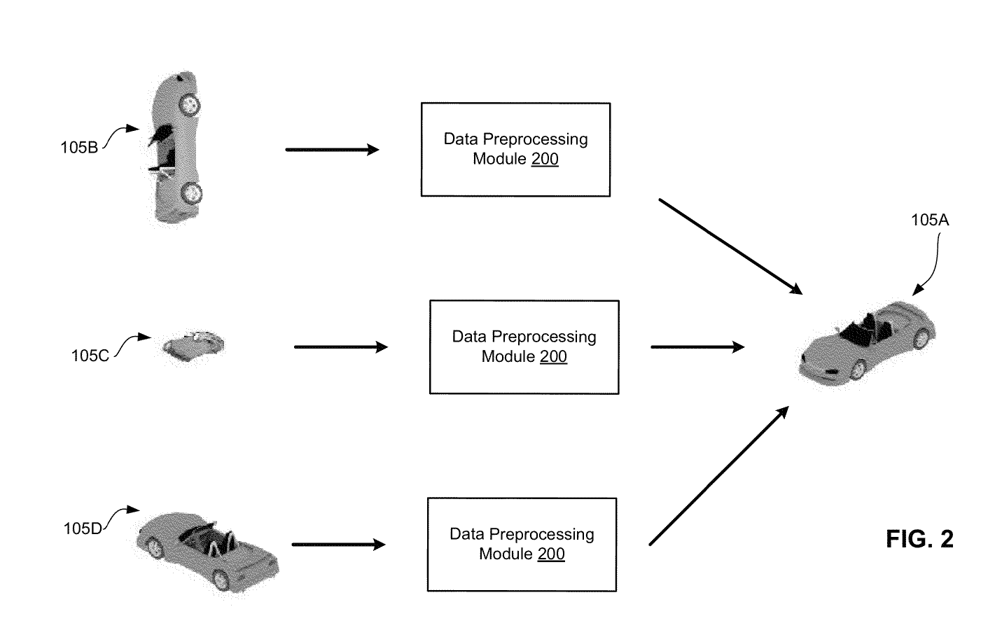

Accordingly, in some embodiments, raw data may be preprocessed before being used to train a recognizer or being provided as input to a recognizer. FIG. 2 illustrates an example of a data preprocessing module 200 that processes raw data (e.g., raw images of cars) and outputs corresponding “rectified” representations that factor out certain variations in the raw data, in accordance with some embodiments.

In the example of FIG. 2, the rectified representations generated by the data preprocessing module 200 may be invariant to one or more transformations such as scaling, translation, rotation around any axis in the 3D space, change in a direction of illumination, etc. As a result, the different images 105B-D, which may be related to each other by one or more of these transformations, may be mapped to the same rectified representation.

Rectified representations may be of any suitable form. For instance, in the example of FIG. 2, the rectified representation corresponding to the images 105B-D is another image 105A of the same car depicted in the images 105B-D. However, as discussed in greater detail below, a rectified representation need not be of the same form as the raw data from which the rectified representation is generated. For example, in some embodiments, a rectified representation of an image may be a multiset of numbers that encodes some information about the image.

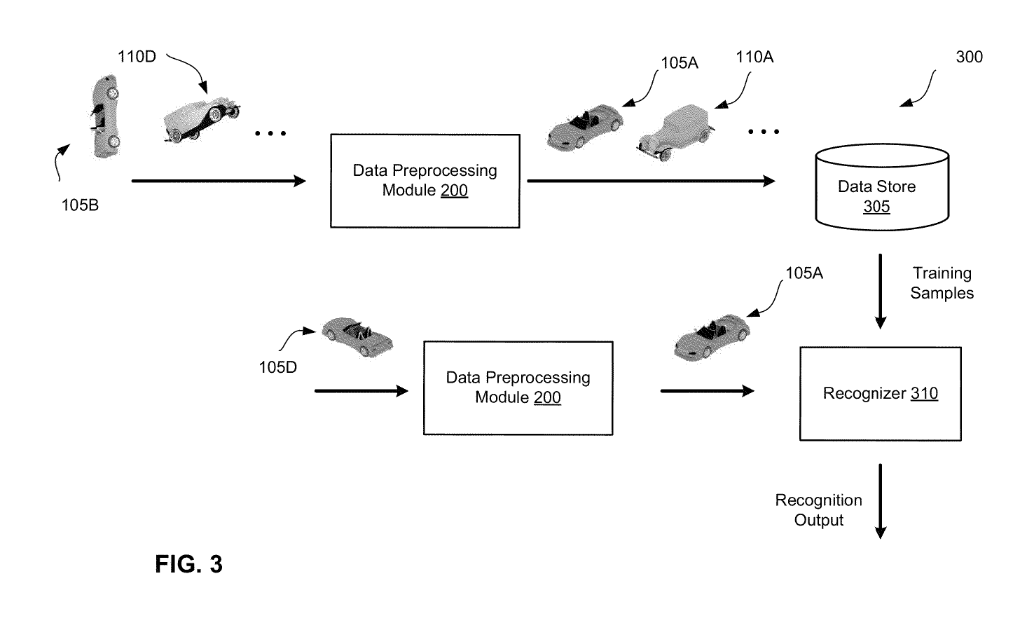

FIG. 3 illustrates an example of a system 300 in which the rectified representations generated by the data preprocessing module 200 are used to train a recognizer 310, or provided as input to the recognizer 310, in accordance with some embodiments. In this example, the images 105B, 110D, . . . may be processed by the data preprocessing module 200 to generate respective rectified representations 105A, 110A, . . . , which may be stored in a data store 305 and may be used to train the recognizer 310 (e.g., by building a statistical model). On the other hand, the image 105D may also be processed by the data preprocessing module 200 to generate the rectified representation 105A, which may be provided as input to the recognizer 310.

As explained above in connection with FIG. 2, the images 105B and 105D may have the same rectified representation 105A because the images 105B and 105D may be related to each other by one or more transformations under which the rectified representations generated by the data preprocessing module 200 are invariant. Thus, if the input image is the result of applying a transformation to a training image, the task of identification may become easy—the recognizer 310 may simply search through all stored representations (e.g., 105A, 110A, . . . ) to find one that is identical to the representation of the input image (e.g., 105A).

Representations that are invariant under one or more transformations of interest may also simplify other recognition tasks such as categorization. For instance, returning to the example shown in FIG. 1, the recognizer is trained and tested in the first experiment using rectified representations of cars such as the representations 105A and 110A, rather than the raw images such as 105B-D and 110D. In the top portion of FIG. 1, recognizer performance in each experiment is plotted as a function of the number of images used to train the recognizer. The solid line represents recognizer performance in the first experiment, where rectified representations are used, and the dashed line represents recognizer performance in the second experiment, where raw images are used.

As these plots illustrate, the recognizer in this example performs much better in the first experiment—roughly 85% accurate with only one training sample in each class of objects (i.e., one rectified representation of a car and one rectified representation of an airplane), and nearly 100% accurate with 20 training samples in each class. By contrast, in the second experiment, the recognizer achieves roughly 50% accuracy with one training sample in each class, and only slight improvement is obtained by increasing the training set size to 20 samples per class.

It should be appreciated that the examples shown in the drawings and described herein are provided merely for purposes of illustration, as the inventive features described herein may be used in other settings. For example, in addition to recognizing objects in 2D images, the inventive features described herein may be used for recognizing objects in 3D images (e.g., images captured by a 3D camera such as a 3D infrared camera). Furthermore, the inventive features described herein may be used for purposes other than recognizing objects in images. In various embodiments, the inventive features may be used to recognize patterns in other types of input data, such as audio data (e.g., speech data), other passive sensory data (e.g., data relating to touch, smell, multi-spectral vision such as infrared, ultraviolet, etc.), active sensory data (e.g., ultrasound data, electromagnetic sensor data such as radar, lidar, etc.), seismic data, financial data, etc.

It should also be appreciate that various embodiments may include any one of the features described herein, any combination of two or more features, or all of the features, as aspects of the present disclosure are not limited to the use of any particular number or combination of the features. Furthermore, aspects of the present disclosure described herein can be implemented in any of numerous ways, and are not limited to any particular implementation techniques. Described below are examples of specific implementation techniques; however, it should be appreciate that other implementations are also possible.

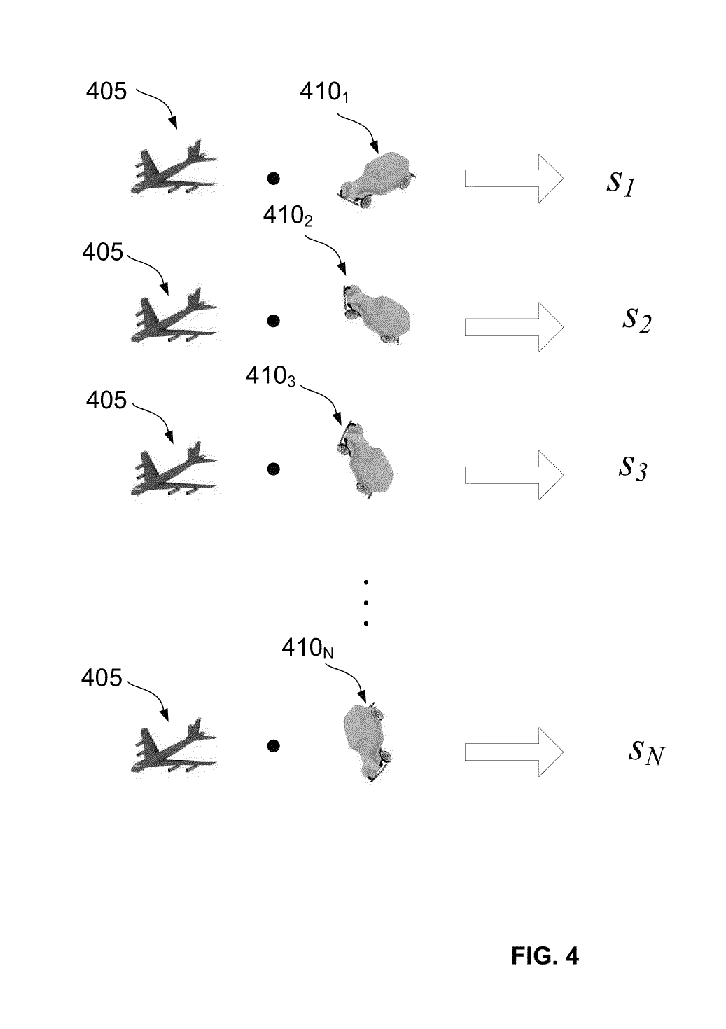

FIG. 4 shows an illustrative example in which an input signal is processed to obtain a representation for an input pattern in the input signal, in accordance with some embodiments. In some embodiments, the representation may be used to train a recognizer (e.g., the illustrative recognizer 310 shown in FIG. 3), for example, using statistical training techniques. Alternatively, or additionally, the representation may be provided as an input to be recognized by the recognizer.

In the example of FIG. 4, the input signal may include one or more images (e.g., a still image or a video), and the input pattern may be an image 405 of an object to be recognized (e.g., an airplane). The input pattern may be combined with one or more representations 410₁, . . . , 410_{N} of a template to obtain one or more values S₁, . . . , S_{N}, which, as explained in greater detail below, may be used to construct a representation of the input pattern 405.

In some embodiments, a template may be a representation of any suitable object for which one or more representations have been generated and/or stored. For instance, in the example shown in FIG. 4, a template may be an image of a car. However, it should be appreciated that a template may be a representation of another type of object (e.g., an airplane, a person's head, hand, or body, etc.), as aspects of the present application are not limited to the use of a template representing any particular type of objects. Furthermore, in some embodiments, a template may be any suitable pattern, and need not be a representation of a physical object. For example, for an input speech signal, a template may be a frame of speech (e.g., 5, 10, 15, 20, 25, 30, etc. milliseconds), a spoken phoneme, a spoken word or phrase, etc.

In some embodiments, the template may be undergoing one or more transformations in the representations. Thus, the representations may be thought of as a “movie” of the object in the template. For instance, in the example shown in FIG. 4, the template is undergoing a rotation in the image plane in the series of representations 410₁, . . . , 410_{N}. Other types of transformations may also be used, such as rotation along another axis in the 3D space, scaling, translation, change in color, change in illumination, change in pose (e.g., where the template is a person), aging or change in expression (e.g., where the template is a person's face), etc., as aspects of the present application are not limited to the recording of any particular type of transformation of a template.

An input pattern may be combined with a representation of a template in any suitable way, as aspects of the present disclosure are not limited to the use of any particular combination operation. For instance, in some embodiments, the input pattern and the representation of the template may be elements of a structure that is endowed with an operator for combining two elements in the structure. In the example shown in FIG. 4, the input pattern 405 and the representations 410₁, . . . , 410_{N} may be elements of an image space with an associated “dot product” (also referred to as an “inner product”). In some embodiments, the dot product of the input pattern 405 and one of the representations 410₁, . . . , 410_{N} may be a number (e.g., a real number, which may be approximated by a floating-point representation) or any other suitable scalar value. Illustrative ways for obtaining a dot product of two images are discussed in greater detail below.

An input pattern may be combined with any suitable number N of representations, such as 1, 5, 10, 15, 20, 25, 30, 35, 40, 45, 50, 55, 60, 65, 70, etc., although other values of N may also be used, as aspects of the present disclosure are not limited to the use of any particular number of representations of a template. In some embodiments, the number N may be selected from a suitable range, such as between 10 and 70, between 20 and 60, between 30 and 50, etc.

In some embodiments, a probability distribution associated with the values S₁, . . . , S_{N} may be analyzed to construct a representation for the input pattern 405. For example, the values S₁, . . . , S_{N} may be analyzed as sample points drawn from a probability distribution. In some embodiments, a probability density function associated with the probability distribution may be estimated using a histogram generated based on the values S₁, . . . , S_{N}, and the histogram may be used as a representation for the input pattern 405.

For instance, in some embodiments, the histogram may count, for each value V=Sᵢ for some i, the number of indices j for which Sⱼ=V=Sᵢ (including the index i). Thus, the histogram may be of the form <<V₁, n₁>, <V₂, n₂>, . . . <V_{L},n_{L}>>, where each V₁ equals Sᵢ for some i, and each n₁ is the number of indices j for which Sⱼ=V₁ (including the index i). However, it should be appreciated that aspects of the present disclosure are not limited to any particular way in which a histogram is represented.

In some embodiments, the histogram may count, for each set in a plurality of sets of values, the number of indices j for which Sⱼ falls within the set. Although not required, the sets of values may be non-overlapping and furthermore may be non-overlapping ranges of values.

In some embodiments, one or more moments generated based on the values S₁, . . . , S_{N} may be used as a representation for the input pattern 405, instead of, or in addition to, a histogram. For example, a first moment (e.g., sample mean), second moment (e.g., sample variance), third moment, fourth moment, etc. may be generated and used as a representation for the input pattern 405. An n^{th} moment, where n=∞, may also be used. Each of these moments may be used either alone or in combination with one or more other moments (e.g., in a suitable linear combination), as aspects of the present disclosure are not limited to any particular number of moment(s) that are used and, if multiple moments are used, any particular way in which the moments are combined.

It should be appreciated that aspects of the present disclosure are not limited to the illustrative techniques described above in connection with FIG. 4 for constructing a representation for an input pattern. For example, in some embodiments, one or more filter operations may be performed on the values S₁, . . . , S_{N}, to remove and/or modify one or more of the values (e.g., to reduce the effect of noise) before a histogram and/or moment is generated. Other variations may also be possible.

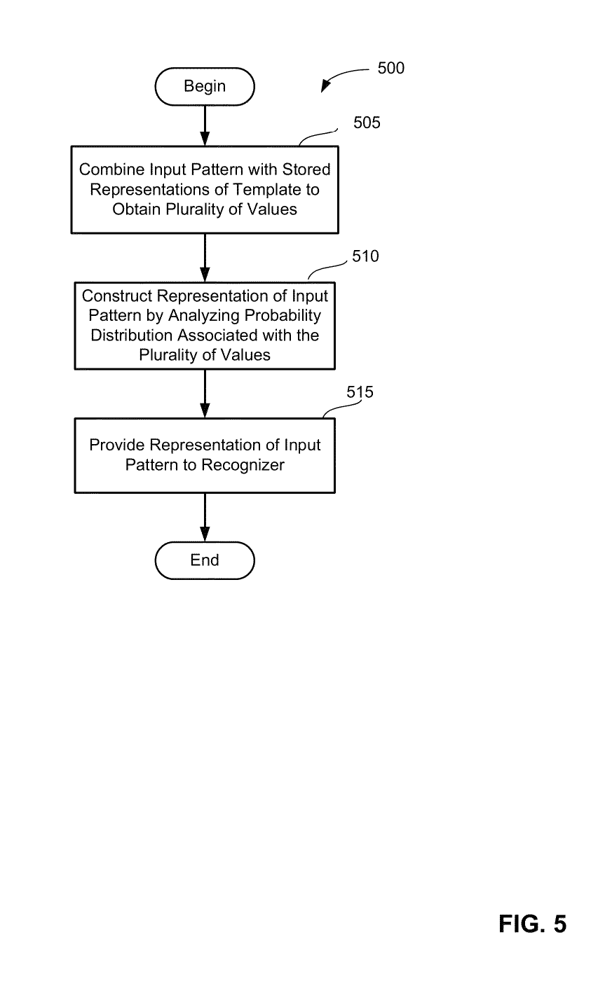

FIG. 5 shows an illustrative method 500 for constructing a representation for an input pattern, in accordance with some embodiments. The method 500 may be used (e.g., by the illustrative data preprocessing module 200 shown in FIG. 2) to process an input signal and construct a representation for an input pattern in the input signal. In some embodiments, the representation may be constructed to have one or more desired properties, such as being invariant to one or more transformations, although such properties are not required.

At act 505, the input pattern may be combined with one or more stored representations of a template to obtain a plurality of values. For instance, as described above in connection with FIG. 4, the input pattern may be combined with each of a plurality of representations of the template to generate a respective value.

At act 510, a representation for the input pattern may be constructed by analyzing a probability distribution associated with the values obtained at act 505. In some embodiments, the values obtained at act 505 may be analyzed as samples drawn from a probability distribution. For example, as described above in connection with FIG. 4, a histogram and/or one or more n^{th} moments for n=1, 2, 3, . . . ∞ may be used to generate a representation for the input pattern. As a more specific example, one or more n^{th} moments for n=2, 3, 4, 5, . . . (n≠∞) may be used. However, it should be appreciated that aspects of the present disclosure are not limited to these examples, as a probability distribution associated with the values obtained at act 505 may be analyzed in other ways.

At act 515, the representation constructed at act 510 may be provided to a recognizer (e.g., the illustrative recognizer 310 shown in FIG. 3). In some embodiments, the representation may be labeled and used to train the recognizer. Alternatively, or additionally, the representation may be provided to the recognizer as an input to be recognized.

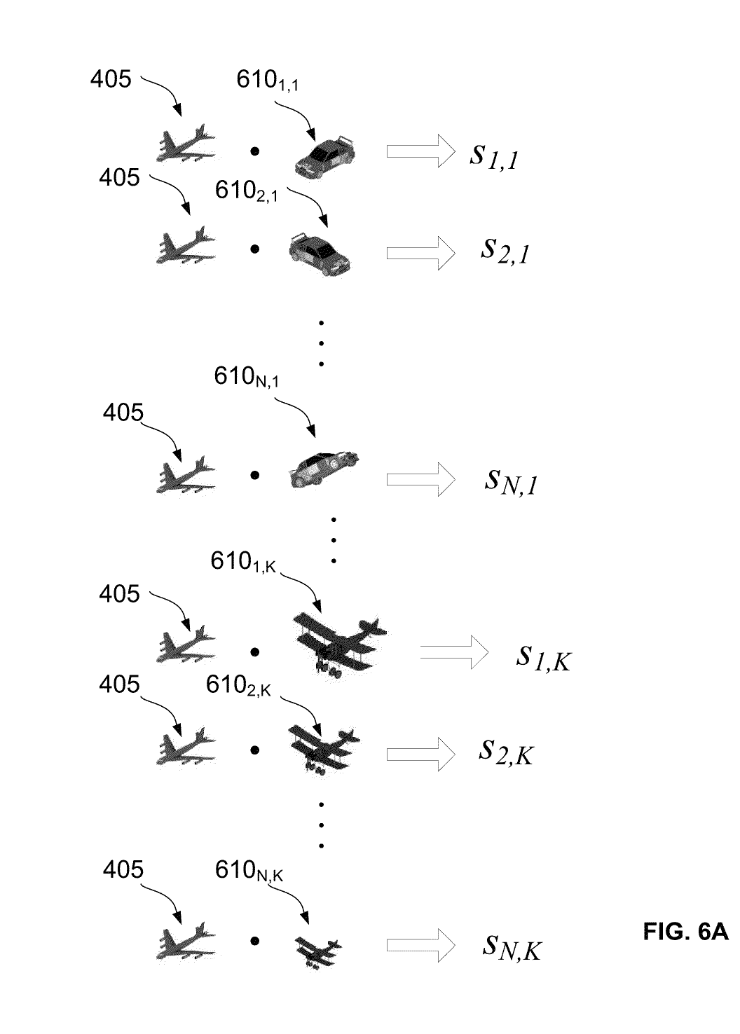

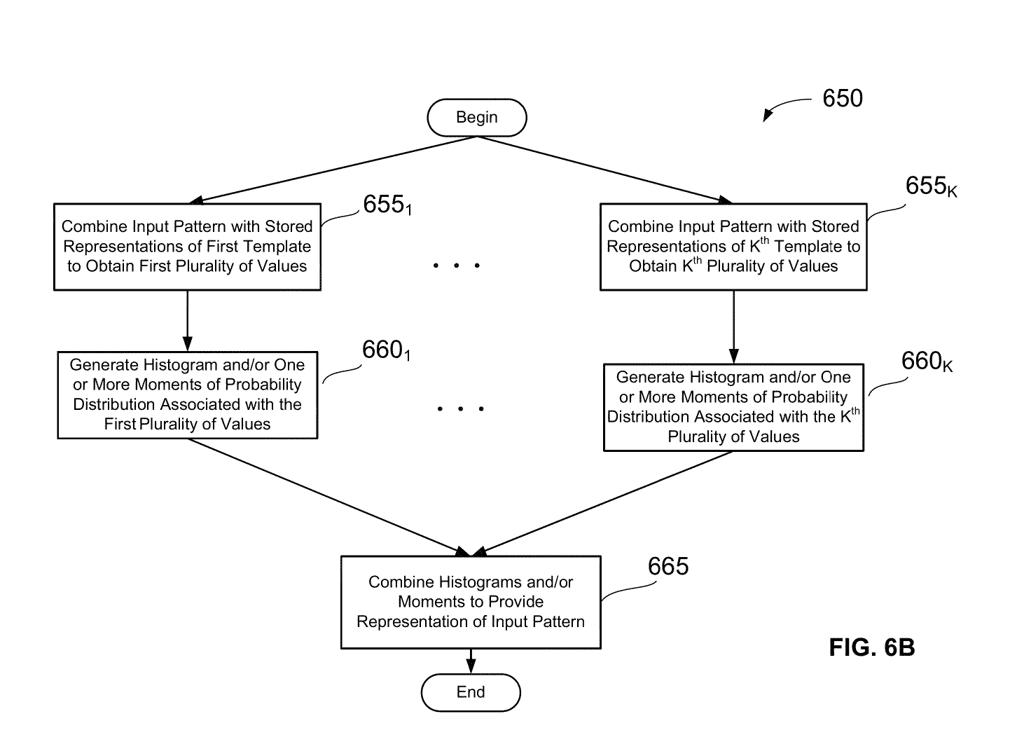

FIG. 6A shows another illustrative example in which an input signal is processed to obtain a representation for an input pattern in the input signal, in accordance with some embodiments. As in the example of FIG. 4, the input signal may include one or more images (e.g., a still image or a video), and the input pattern may be an image 405 of an object to be recognized (e.g., an airplane). However, in this example, the input pattern 405 is combined with representations of multiple templates. For instance, the input pattern may be combined with K different templates (e.g., images of a car, an airplane, a bike, a person's head, hand, or body, etc.).

The inventors have recognized and appreciated that by using a smaller number of templates (e.g., 1, 2, 3, 4, 5 . . . ), less storage may be needed to store the representations of the templates, and less processing may be needed to construction the representation. However, the resulting representation may include less information about the input pattern. For instance, a collision may occur due to loss of pertinent information (e.g., where the same representation is output for two different input patterns, even though the two patterns are not related by any relevant transformation). Accordingly, in some embodiments, the number K of different templates may be selected to reduce a likelihood of collision. For example, the number K may be between 10 and 100 (e.g., 10, 20, 30, 40, 50, 60, 70, 80, 90, etc.). However, it should be appreciated that aspects of the present disclosure are not limited to the use of any particular number of templates.

In the example of FIG. 6A, K templates are used and, for each k=1, . . . , K, the input pattern is combined with one or more representations 610_{1,k}, . . . , 610_{N,k} of the k^{th} template to obtain one or more values S_{1,k}, . . . , S_{N,k}. The input pattern may be combined with each of these representations in any suitable way, such as by using any one or more of the techniques described above in connection with FIG. 4.

In some embodiments, a representation for the input pattern may be constructed by analyzing a probability distribution associated with the values S_{1,k}, . . . , S_{N,k} for each k=1, . . . , K. For example, a histogram and/or one or more moments may be generated for each k=1, . . . , K, and the K histograms and/or K sets of moments may together be used to construct the representation for the input pattern. In some embodiments, the histograms and/or sets of moments may be concatenated and the result may be used as the representation for the input pattern. However, other ways to use the histograms and/or sets of moments are also possible, as aspects of the present disclosure are not so limited.

In the example of FIG. 6A, some or all of the K templates may be undergoing one or more transformations in the corresponding representations. For instance, the first template in the series of representations 610_{1,1}, . . . , 610_{N,1} is undergoing multiple rotations along different axis in the 3D space, whereas the K^{th} template in the series of representations 610_{1,K}, . . . , 610_{N,K} is being scaled down to a smaller size. However, it should be appreciated that these transformations are merely illustrative, as other types of transformations may also be recorded in the representations.

Furthermore, aspects of the present disclosure are not limited to having the same number N of representations for each of K different templates. In some embodiments, different numbers of representations may be used for two or more of the templates, respectively. Further still, aspects of the present disclosure are not limited to the use of templates that depict different objects. In some embodiments, two or more of the K templates may depict the same object, but the object may be undergoing different transformations.

FIG. 6B shows another illustrative method 650 for constructing a representation for an input pattern, in accordance with some embodiments. The method 650 may be used (e.g., by the illustrative data preprocessing module 200 shown in FIG. 2) to process an input signal and construct a representation for an input pattern in the input signal. In some embodiments, the representation may be constructed to have one or more desired properties, such as being invariant to one or more transformations, although such properties are not required.

At acts 655₁, . . . , 655_{K}, the input pattern maybe combined with stored representations of, respectively, K different templates. For instance, as described above in connection with FIG. 4, the input pattern may be combined with each of a plurality of representations of each template to generate a respective value.

In some embodiments, two or more of the acts 655₁, . . . , 655_{K} may be performed in parallel. This may reduce execution time by spreading the computational load across multiple processors. However, aspects of the present disclosure are not limited to the use of distributed computation, as in some embodiments the acts 655₁, . . . , 655_{K} may be performed one at a time (e.g., on the same processor).

At act 660₁, . . . , 660_{K}, probability distributions associated with the values obtained, respectively, at acts 655₁, . . . , 655_{K} may be analyzed. For example, as described above in connection with FIG. 4, a histogram and/or one or more n^{th} moments for n=1, 2, 3, . . . ∞ may be used to generate a representation for the input pattern. As a more specific example, one or more n^{th} moments for n=2, 3, 4, 5, . . . (n≠∞) may be used. However, it should be appreciated that aspects of the present disclosure are not limited to these examples, as the probability distributions associated with the values obtained, respectively, at acts 655₁, . . . , 655_{K} may be analyzed in other ways.

At act 655, the histograms and/or sets of moments generated at the acts 655₁, . . . , 655_{K} may be combined to provide a representation of the input pattern. In some embodiments, the histograms and/or sets of moments may be concatenated and the result may be used as the representation for the input pattern. However, other ways to use the histograms and/or sets of moments are also possible, as aspects of the present disclosure are not so limited.

The representation constructed at act 655 may be used in any suitable manner, as aspects of the present disclosure are not so limited. In some embodiments, the representation may be provided to a recognizer (e.g., the illustrative recognizer 310 shown in FIG. 3). In some embodiments, the representation may be labeled and used to train the recognizer. Alternatively, or additionally, the representation may be provided to the recognizer as an input to be recognized. Other uses may also be possible.

Following below are detailed mathematical formulations that support various techniques for constructing a representation of an input pattern, in accordance with some embodiments of the present disclosure. It should be appreciated that such examples of specific implementations and applications are provided solely for purposes of illustration, and that the inventive concepts presented herein are not limited to any particular implementation or application, as other implementations and applications may also be suitable.

As discussed above, representations that are invariant to translation, scale and/or other transformations may reduce the sample complexity of learning, allowing recognition of new object classes from very few (e.g., one, two, three, four, five, etc.) examples—a hallmark of human recognition. In some embodiments, empirical estimates of one-dimensional projections of a distribution induced by a group of affine transformations may represent a unique and invariant signature associated with an image. Projections yielding invariant signatures for future images may be learned automatically and/or updated continuously during unsupervised visual experience. In some embodiments, a module performing filtering and pooling, like simple and complex cells as proposed by Hubel and Wiesel, may compute such estimates. For example, a pooling stage may estimate a one-dimensional probability distribution. Invariance from observations through a restricted window may be equivalent to a sparsity property with respect to a transformation, which may yield templates that are: a) Gabor for optimal simultaneous invariance to translation and scale, or b) specific for complex, class-dependent transformations such as rotation in depth of faces.

In some embodiments, hierarchical architectures comprising a basic Hubel-Wiesel module may inherit properties of invariance, stability, and/or discriminability while capturing a compositional organization of the visual world in terms of wholes and parts, and may be invariant to complex transformations that may only be locally affine. Also, the inventors have recognized and appreciated that the main computational goal of the ventral stream of the visual cortex may be to provide a hierarchical representation of new objects/images which may be invariant to transformations, stable, and/or discriminative for recognition. Such a representation may be continuously learned in an unsupervised way during development and natural visual experience.

Illustrative hierarchical architectures are described herein, for example, of the ventral stream in the visual cortex. As discussed above, a computational goal of the ventral stream may be to compute a representation of objects which is invariant to transformations. In some embodiments, a process based on high-dimensional dot products may use previously captured “movies” of objects transforming to encode new images in an invariant way. The inventors have recognized and appreciated that invariance may imply several properties of the ventral stream organization and of the tuning of its neurons. Illustrative techniques are provided for the next phase of machine learning beyond supervised learning: the unsupervised learning of representations that reduce the sample complexity of the final supervised learning stage.

Hubel and Wiesel's original proposal for visual area V1 describes a module comprising complex cells (C-units) that combine the outputs of sets of simple cells (S-units) with identical orientation preferences but differing retinal positions. It was known that such an architecture may be used to construct translation-invariant detectors. This concept was used in some networks for visual recognition, including variants of HMAX and convolutional neural nets.

Concepts and techniques are described herein for recognition, such as visual recognition relevant for computer vision and possibly for the visual cortex. The inventors have recognized and appreciated that a representation of images and image patches, with a feature vector that is invariant to a broad range of transformations (e.g., translation, scale, viewpoint angle, expression of a face, pose of a body, etc.) may allow recognition of objects from only a few labeled examples, as humans do.

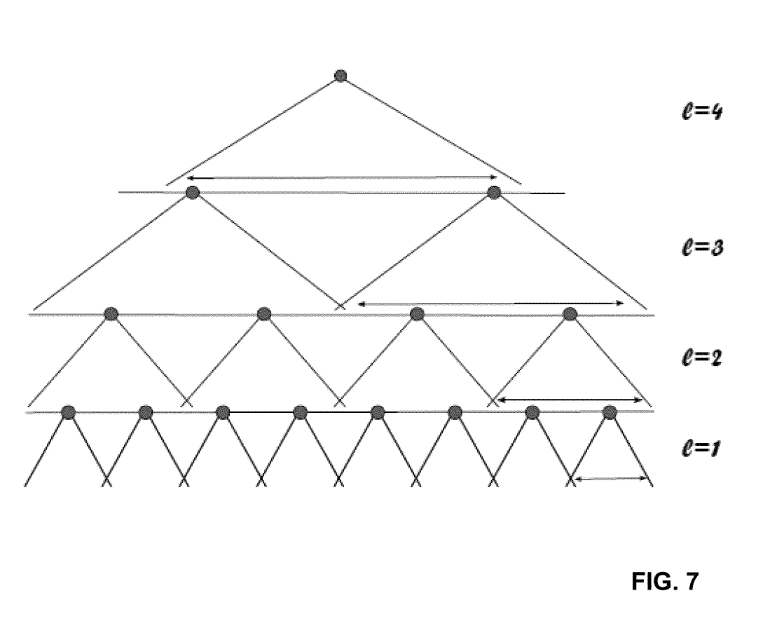

FIG. 7 shows an illustrative hierarchical architecture built from HW-modules, in accordance with some embodiments. The inventors have recognized and appreciated that hierarchical architectures of Hubel-Wiesel (‘HW’) modules (indicated by ̂ in FIG. 7) may provide such invariant representations while maintaining discriminative information about the original image. Each ̂-module may provide a feature vector (which is sometimes referred to herein as a “signature”), for the part of the visual field that is inside its “receptive field.” The signature may be invariant to (R²) affine transformations within the receptive field. The hierarchical architecture may be used to generate a set of signatures for different parts of the image, which may be invariant to one or more locally affine transformations (which may include globally affine transformations of the whole image). The inventors have recognized and appreciated that invariance of such hierarchies may result from covariance of such architectures for image transformations and from the uniqueness and invariance of individual module signatures.

In some embodiments, a basic HW-module is used in connection with machine learning, machine vision, and neuroscience. In the example of FIG. 7, each red circle represents the signature vector computed by the associated module (e.g., an output of a complex cell) and double arrows represent the module's receptive field (e.g., a part of a neural image visible to the module). In some embodiments (e.g., where a transformation includes a translation), a module's receptive field may be used as a pooling range.

In the example of FIG. 7, a neural “image” is at level 0, at the bottom. The vector computed at the top of the hierarchy may include invariant features for the whole image and may be fed as input to a supervised learning machine such as a classifier. In some embodiments, signatures from modules at intermediate layers may also be input to classifiers for objects and parts.

Invariant Representations and Sample Complexity

The inventors have recognized and appreciated that an important aspect of intelligence is the ability to learn, and that existing supervised learning algorithms may not be able to learn effectively from very few labeled examples, as people and animals do. (For instance, a child or a monkey may learn a recognition task from just a few examples.) The inventors have further recognized and appreciated that invariance to transformations may allow reduction in sample complexity of object recognition, as images of the same object may differ from each other because of simple transformations such as translation, scale (e.g., distance), etc., or more complex deformations such as rotation in depth (e.g., change in viewpoint angle), change in pose of a body, change in expression of a face, aging, etc.

Complexity in recognition tasks is often due to viewpoint and illumination nuisances that swamp the intrinsic characteristics of an object. The inventors have recognized and appreciated that recognition (e.g., both identification, such as identification of a specific car relative to other cars, as well as categorization, such as distinguishing between cars and airplanes) may be much easier (e.g., only a small number of training examples would be needed to achieve a given level of performance), if the images of objects were rectified with respect to one or more transformations, or if the image representation itself were invariant under the transformations.

For example, identification may be simplified as the complexity in recognizing exactly the same object (e.g., an individual face) may only be due to transformations. As for the complexity of categorization, an illustrative example is shown in FIG. 1 and discussed above. The inventors have recognized and appreciated that if an oracle factors out all transformations in images of many different cars and airplanes, providing “rectified” images with respect to viewpoint angle, illumination, position, and scale, the problem of categorizing cars vs. airplanes may become easy—the categorization task may be done accurately with very few labeled examples. The inventors have recognized and appreciated that the ventral stream in the visual cortex may approximate such an oracle by providing a quasi-invariant signature for images and image patches.

In the example of FIG. 1, good performance is obtained from a single training image of each class, using a simple classifier. Thus, the sample complexity of the categorization problem may be low. The inventors have recognized and appreciated that the size of the universe of possible images generated by different viewpoints (e.g., variations in scale, position and/or rotation in 3D) may be much greater than the size of true intra-class variability (e.g. different types of cars). For example, give certain resolution and size of the visual field, the number of all images may be several orders of magnitude larger than the number of distinguishable types of cars (e.g., around 10³ different types of cars).

FIG. 1 illustrates the sample complexity for the task of categorizing cars vs. airplanes from their raw pixel representations, in accordance with some embodiments. In this example, performance of a nearest-neighbor classifier (e.g., distance metric=1−correlation) is evaluated as a function of the number of examples per class used for training. Each test uses 74 randomly chosen images to evaluate the classifier. Error bars in FIG. 1 represent +/−1 standard deviation computed over 100 training/testing splits using different images out of the full set of 440 objects X the number of transformation conditions. The solid line in part A of FIG. 1 shows classifier performance in the rectified task, where all training and test images are rectified with respect to all transformations. Example images for the rectified task are shown in part B of FIG. 1. The dashed line in part B of FIG. 1 shows classifier performance in the unrectified task, where variations in position, scale, direction of illumination, and rotation around any axis (including rotation in depth) are allowed. Example images for the unrectified task are shown in part C of FIG. 1. The images are created using 3D models from the Digimation model bank and rendered with Blender.

Invariance and Uniqueness

In some embodiments, an image or image patch I is associate with a “signature,” which may be a vector that is unique and invariant with respect to a group of transformations. (The image or image patch I may or may not have been transformed by the action of a group like an affine group in R².) For example, a group of transformations may be compact and finite (e.g., of cardinality |G|) However, it should be appreciated that aspects of the present disclosure are not limited to the use of transformations that are groups.

A generic group element and its (unitary) representation are indicated herein with the same symbol g, and the element's action on an image is indicated as gI(x)=I(g⁻¹x) (e.g. a translation may be indicated as g_{ξ}I(x)=I(x−ξ)).

In some embodiments, an “orbit” O_{I} may be the set of images gI generated from a single image I under the action of the group. Two images may be considered equivalent when they belong to the same orbit: I:I′ if ∃g∈G such that I′=gI. Thus, an orbit may be invariant and unique. For instance, if two orbits have a point in common, then the two orbits may be identical everywhere. Conversely, two orbits may be different if none of the images in one orbit coincide with any image in the other.

The inventors have recognized and appreciated that two orbits may be characterized and compared in several different ways. For instance, a distance between orbits may be defined in terms of a metric on images along the orbits, but it is unclear how neurons may perform such computations. In some embodiments, a different approach is taken the inventors have recognized and appreciated that two empirical orbits may be the same irrespective of the ordering of the points on the orbits. For instance, a probability distribution P_{I} induced by the group's action on images I may be used (e.g., by using gI as a realization of a random variable). The inventors have recognized and appreciated that if two orbits coincide then the associated distributions under the group G may be identical:

I≈I′ [symbol] O_{I}=O_{I′} [symbol] P_{I}=P_{I′}. (1)

The inventors have recognized and appreciated that the distribution P_{I} may be invariant and discriminative. However, the inventors have also recognized and appreciated that P_{I} may inhabit a high-dimensional space and therefore an estimation of P_{I} may be complex. In particular, it is unclear how neurons or neuron-like elements could estimate P_{I}.

The inventors have recognized and appreciated that simple operations for neurons are (high-dimensional) inner products, [symbol] •,• [symbol] between inputs and stored “templates” which are neural images. The inventors have recognized and appreciated that, by applying classical results (such as the Cramer-Wold theorem), a probability distribution P_{I} may be almost uniquely characterized by K one-dimensional probability distributions P [symbol] _{I,t}_{^{k}} [symbol] induced by the (one-dimensional) results of projections [symbol] I,t^{k} [symbol] , where t^{k}, k=1, . . . , K are a set of randomly chosen images called templates.

The inventors have recognized and appreciated that a probability function in d variables (e.g., the image dimensionality) may induce a unique set of one-dimensional projections which may be discriminative. For example, the inventors have recognized and appreciated that, empirically, a small number of projections is usually sufficient to discriminate among a finite number of different probability distributions. The inventors have further recognized and appreciated that an approximately invariant and unique signature of an image I may be obtained from the estimates of K one-dimensional probability distributions P [symbol] _{I,t}_{^{k}} [symbol] for k=1, . . . , K, and that the number K of projections needed to discriminate n orbits, induced by n images, up to precision ∈ (and with confidence 1−δ²) may be

$$K \geq \frac{c}{{ɛ}^{2}} log \frac{n}{δ} ,$$

where c is a universal constant. Therefore, the discriminability question may be answered positively (up to ∈) by using empirical estimates of the one-dimensional distributions P [symbol] _{I,t}_{^{k}} [symbol] of projections of the image onto a finite number of templates t^{k}, k=1, . . . , K under the action of the group.

Memory-Based Learning of Invariance

The inventors have recognized and appreciated that the estimation of P [symbol] _{I,t}_{^{k}} [symbol] may involve the observation of the image and “all” of its transforms g^{I}. However, the inventors have also recognized and appreciated that it is possible to compute an invariant signature for a new object seen only once (e.g., recognizing a new face at different distances after just one observation). In that respect, the inventors have recognized and appreciated that [symbol] gI,t^{k} [symbol] = [symbol] I,g⁻¹t^{k} [symbol] . That is, the same one-dimensional distribution may be obtained from the projections of the image and all its transformations onto a fixed template, as from the projections of the image onto all the transformations of the same fixed template. Therefore, the distributions of the variables [symbol] I,g⁻¹t^{k} [symbol] and [symbol] gI,t^{k} [symbol] may be the same.

Accordingly, in some embodiments, a system may store for each template t^{k} all its transformations gt^{k} for all g∈G and later obtain an invariant signature for new images without any explicit information regarding the transformations g or of the group to which they belong. That is, the inventors have recognized and appreciated that implicit knowledge of the transformations, in the form of the stored transformations of templates, may allow the system to automatically generate representations for new inputs that are also invariant to those transformations.

In some embodiments, one-dimensional Probability Density Functions (PDFs) P [symbol] _{I,t}_{^{k}} [symbol] may be estimated using histograms such as μₙ^{k}(I)=1/|G|Σᵢ₌₁^{|G|}ηₙ( [symbol] I,gᵢt^{k} [symbol] ), where ηₙ, n=1, . . . , N is a set of nonlinear functions. The inventors have recognized and appreciated that a visual system need not recover the actual probabilities from the empirical estimate in order to compute a unique signature, and that the set of μₙ^{k}(I) values may identify the associated orbit and therefore may be sufficient. In this manner, mechanisms capable of computing for future objects representations that are invariant under affine transformations may be learned and maintained in an unsupervised, automatic way by storing and updating sets of transformed templates which are unrelated to those future objects.

In some embodiments, a normalization of the elements of the inner product

$$( e . g . 〈 I , {g}_{i} {t}^{k} 〉 ↦ \frac{〈 I , {g}_{i} {t}^{k} 〉}{‖ I ‖ ‖ {g}_{i} {t}^{k} ‖} )$$

may be performed to allow the property [symbol] gI,t^{k} [symbol] = [symbol] I,g⁻¹t^{k} [symbol] .

A Theory of Pooling

The inventors have recognized and appreciated that invariant signatures may be computed in several ways from one-dimensional probability distributions. For example, the inventors have recognized and appreciated that the μₙ^{k}(I) components may represent the moments mₙ^{k}(I)=1/|G|Σᵢ₌₁^{|G|}( [symbol] I,gᵢt^{k} [symbol] )ⁿ of an empirical distribution, instead of representing the empirical distribution itself directly.

The inventors have further recognized and appreciated that under certain conditions, the set of all moments may uniquely characterize the one-dimensional distribution P [symbol] _{I,t}_{^{k}} [symbol] (and thus P_{I}), while a set of one or more moments may be used to approximate the distribution. For example, a first moment (n=1) may correspond to pooling via sum/average (which may be used without a nonlinearity), a second moment (n=2) may correspond to “energy models” of complex cells, and a moment for very large n, or of infinite order (n=∞) may be related to max pooling. Each of these different pooling functions may be invariant and may capture part of the full information contained in the PDFs.

The inventors have recognized and appreciated that using just one of the moments may provide sufficient selectivity to a hierarchical architecture. Other nonlinearities may also possible. The inventors have also recognized and appreciated that the techniques described herein may be used to identify a desirable pooling function in any particular setting. By contrast, in conventional systems, pooling functions were selected on a case-by-case basis for each given application setting.

Implementations

Implementations of some of the inventive techniques described herein are shown to perform well on a number of databases of natural images. One set of tests is performed using a HMAX, an architecture in which pooling is done with a max operation and invariance to translation and scale is mostly “hardwired” (i.e., programmed specifically, instead of learned). High performance for non-affine and even non-group transformations is also shown on large databases of face images.

Invariance Implies Localization and Sparsity

In some embodiments, representations may be generated that are invariant under transformations that are compact groups, such as rotations in the image plane. In some embodiments, representations may be generated that are invariant under transformations that are locally compact, such as translation and scaling. Each of the modules of FIG. 7 may observe only a part of a transformation's full range, and each ̂-module may have a finite pooling range, which may correspond to a finite “window” over the orbit associated with an image.

The inventors have recognized and appreciated that exact invariance for each module may be equivalent to a condition of localization/sparsity of the dot product between an image and a template. For example, for a group parameterized by one parameter r, the localization/sparsity condition may be expressed as:

[symbol]

I,gᵣt^{k} [symbol] =0 |r|>a. (2)

The inventors have recognized and appreciated that this condition may be a form of sparsity of the generic image I with respect to a dictionary of templates t^{k} (under a group), which may be obtained using sparse encoding in the sensory cortex. The inventors have also recognized and appreciated that optimal invariance for translation and scale may imply Gabor functions as templates.

The inventors have recognized and appreciated that Equation (2), if relaxed to hold approximately, that is [symbol] I_{C},gᵣt^{k} [symbol] ≈0 |r|>a, may become a sparsity condition for the class of I_{C} with respect to the dictionary t^{k} under the group G when restricted to a subclass I_{C} of similar images. This property, which may be similar to compressive sensing “incoherence” (but in a group context), may be satisfied when I and t^{k} have a representation with rather sharply peaked autocorrelation (and correlation). When such a condition is satisfied, a basic HW-module equipped with such templates may provide approximate invariance to non-group transformations such as rotations in depth of a face or its changes of expression.

In summary, the inventors have recognized and appreciated that Equation (2) may be satisfied in two different regimes. The first one, exact and valid for generic I, may yield optimal Gabor templates. The second regime, approximate and valid for specific subclasses of I, may yield highly tuned templates, specific for the subclass. For example, generic, Gabor-like templates may be in the first layers of a hierarchy and highly specific templates may be at higher levels. The inventors have recognized and appreciated that incoherence may improve with increasing dimensionality.

Hierarchical Architectures

As discussed above, architectures comprising basic HW-modules may have a single layer, or multiple layers (e.g., as in the hierarchical architecture shown in FIG. 7). The inventors have recognized and appreciated that it may be desirable to allow the recursive use of single module properties at all layers in a hierarchical architecture of repeated HW-modules. The inventors have recognized and appreciated that such recursive use may be possible if a property of covariance is satisfied. For example, each layer l may be said to have a covariant response if the distribution of the values of each projection is the same for the image or the template transformations (i.e., distr( [symbol] μₗ(gI),μₗ(t^{k}) [symbol] )=dist( [symbol] μₗ(I)μₗ(gt^{k}) [symbol] ),∀k).

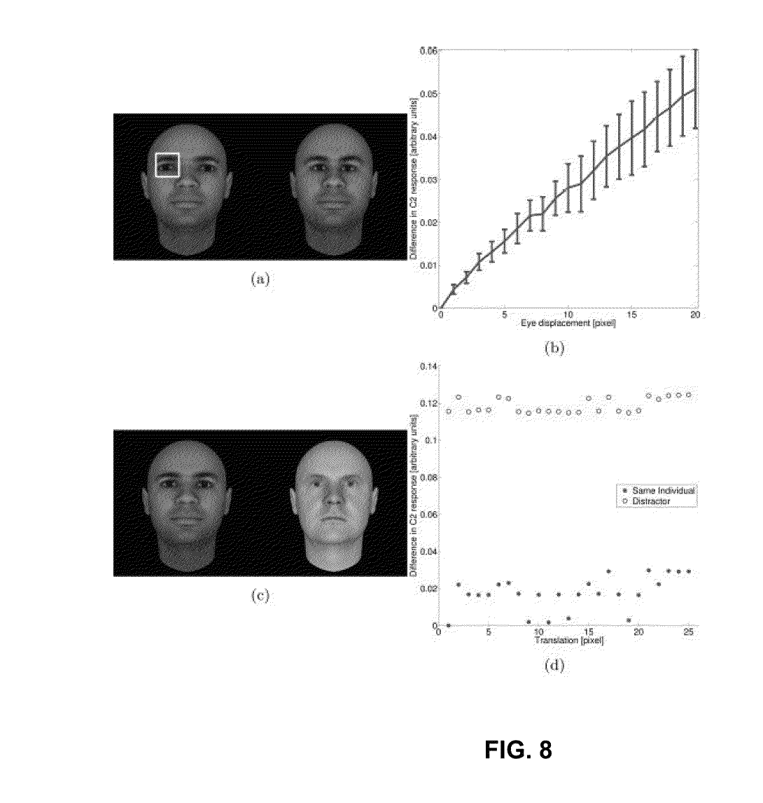

The inventors have recognized and appreciated that one-layer networks may provide invariance to global transformations of the whole image (and exact invariance if the transformations are a subgroup of the affine group in R²), while providing a unique global signature which is stable with respect to small perturbations of the image. In some embodiments, a hierarchical architecture (e.g., the hierarchical architecture shown in FIG. 7) may be used to generate an invariant representation not only for the whole image, but also for all parts of it which may contain objects and object parts. Furthermore, a hierarchical architecture may be used to provide invariance to global transformations that are not affine, but are locally affine (e.g., affine within the pooling range of some of the modules in the hierarchy). Examples of invariance and stability for wholes and parts are shown in FIG. 8 and discussed below.

It should be appreciated that local and global one-layer architectures may be used in the same visual system without a hierarchical configuration. However, in addition to some of the advantages discussed above, a hierarchical configuration may provide other advantages such as compositionality and reusability of parts. For example, a hierarchical configuration may be used to avoid issues of sample complexity and connectivity that may arise in one-stage architectures. In addition, a hierarchical configuration may be used to capture a hierarchical organization of the visual world, where scenes are composed of objects which are themselves composed of parts. Objects, which may be parts of a scene, may move in the scene relative to each other without changing their identities, and often changing the scene only in a minor way (e.g., the appearance or location of the object). Thus, it may be desirable to allow global and local signatures from all levels of the hierarchy to access memory to enable the categorization and identification of whole scenes as well as of patches corresponding to objects and their parts.

In the illustrative architecture of FIG. 7, each ̂-module may provide uniqueness, invariance, and stability at different levels, over increasing ranges from bottom to top. Thus, in addition to providing the desired properties of invariance, stability and discriminability, these architectures may match the hierarchical structure of the visual world and may allow retrieval of items from memory at various levels of size and complexity.

FIG. 8 shows empirical results that demonstrate the properties of invariance, stability and uniqueness of a hierarchical architecture, in accordance with some embodiments. In this example, a 2-layer implementation in HMAX is used, and the images analyzed are 200×200 pixels.

Part (a) of FIG. 8 shows a reference image on the left and a deformation of the reference image (e.g., the eyes are closer to each other) on the right. Part (b) of FIG. 8 shows that an HW-module at layer 2 (c₂) whose receptive fields contain the whole face may provide a signature vector which is stable (e.g., Lipschitz stable) with respect to the deformation. The HW-module thus represents the top of a hierarchical, convolutional architecture. The Euclidean norm of the signature vector is plotted in part (b) of FIG. 8, and the error bars represent ±1 standard deviation.

In the example of FIG. 8, the c₁ and c₂ vectors are not only invariant but also selective. Part (c) of FIG. 8 shows two different images that are presented at different locations in a visual field. The Euclidean distance between the signatures of a set of HW-modules at layer 2 with the same receptive field (e.g., the whole image) and a reference vector is shown in part (d) of FIG. 8. The plots in part (d) of FIG. 8 show that the signature vector in this example is invariant to global translation and is discriminative (e.g., between the two faces).

The inventors have recognized and appreciated that hierarchical architectures may be more effective than one-layer architectures in dealing with the problem of partial occlusion and the problem of clutter in object recognition, because hierarchical architectures may provide signatures for image patches of several sizes and locations. Additionally, the inventors have recognized and appreciated that both hierarchical feedforward architectures and more complex architectures (e.g. recurrent architectures) may be used.

Visual Cortex

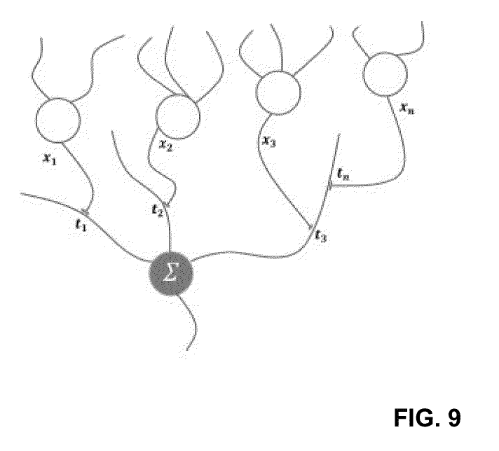

The inventors have recognized and appreciated a correspondence between some of the techniques described herein for generating a representation of an input pattern and well-known capabilities of cortical neurons. In that respect, the inventors have recognized and appreciated that basic elements of digital computers may each have three or fewer connections, whereas each cortical neuron may have 10³-10⁴ synapses. A single neuron may be capable of computing high-dimensional (e.g., 10³-10⁴) inner products between an input vector and a stored vector of synaptic weights. FIG. 9 shows an illustrative neuron that is capable of performing high-dimensional inner products between inputs on its dendritic tree and stored synapse weights.

The inventors have recognized and appreciated that an HW-module of “simple” and “complex” cells may be thought of as “looking at” an image through a window defined by the receptive fields of the cells. During development (or more generally, during visual experience), each simple cell in a set of |G| simple cells may store in its synapses an image patch t^{k} and transformations g₁t^{k}, . . . , g_{|G|}t^{k}, as images of objects in the visual environment undergo affine transformations. Such storage may be done, possibly at separate times, for K different image patches t^{k} (templates), k=1, . . . , K. Each gt^{k} for g∈G may be a “movie” (e.g., a sequence of frames) capturing the image patch t^{k} transforming. In this manner, unconstrained transformations may be learned in an unsupervised way.

The inventors have recognized and appreciated that unsupervised (Hebbian) learning may be a mechanism by which a “complex” cell pools over several simple cells. For example, an unsupervised Foldiak-type rule may be followed: cells that fire together may be wired together. At the level of complex cells, this rule may determine equivalence classes among simple cells, which may reflect observed time correlations in the real world (e.g., how an image has transformed at various points in time). Time continuity, induced by the Markovian physics of the world, may allow associative labeling of stimuli based on their temporal contiguity.

At a later time, when a new image is presented, the simple cells may compute [symbol] I,gᵢt^{k} [symbol] for i=1, . . . , |G|. The next step may be to estimate the one-dimensional probability distribution of such a projection, which may be the distribution of the outputs of the simple cells. Complex cells may pool the outputs of simple cells, for example, by computing μₙ^{k}(I)=1/|G|Σᵢ₌₁^{|G|}σ( [symbol] I,gᵢt^{k} [symbol] +nΔ), where σ is a smooth version of the step function (σ(x)=0 for x≦0, σ(x)=1 for x>0) and n=1, . . . , N. Each of the N complex cells may estimate one bin of an approximated CDF (cumulative distribution function) for P [symbol] _{I,t}_{^{k}} [symbol] .

For example, the complex cells may compute, instead of an empirical CDF, one or more of its moments as discussed above. For instance, a first moment may correspond to the mean of the dot products, a second moment may correspond to an energy model of complex cells, and a moment of very high order may correspond to a max operation. In a conventional interpretation of available physiological data, simple and complex cells in V1 may be described in terms of energy models, but the inventors have recognized and appreciated that empirical histogramming by sigmoidal nonlinearities with different offsets may fit the diversity of data even better.

As discussed above, the inventors have recognized and appreciated that a template and its transformed versions may be learned from unsupervised visual experience through Hebbian plasticity. Furthermore, the inventors have recognized and appreciated that Hebbian plasticity (e.g., as formalized by Oja) may yield Gabor-like tuning. For example, the templates may provide optimal invariance to translation and scale.

There is psychophysical and neurophysiological evidence that the brain employs learning rules such as those described above. A second step of Hebbian learning may be responsible for wiring complex cells to simple cells that are activated in close temporal contiguity and thus correspond to the same patch of image undergoing a transformation in time.

The inventors have recognized and appreciated that the localization condition in Equation (2) may be satisfied by images and templates that are similar to each other, which may provide invariance to class-specific transformations. This recognition is consistent with the existence of class-specific modules in primate cortex such as a face module and a body module. The inventors have further recognized and appreciated that the same localization condition may suggest general Gabor-like templates for generic images in the first layers of a hierarchical architectures and specific, sharply tuned templates for the last stages of the hierarchy. This is consistent with physiology data concerning Gabor-like tuning in V1 and possibly in V4. These incoherence properties of visual signatures may be used in information processing in settings other than vision, such as memory access.

In some embodiments, techniques are provided for constructing representations of new objects/images in terms of signatures which may be invariant to transformations learned during visual experience, thereby allowing recognition from very few labeled examples (e.g., just one).

Setup and Definitions

Let X be a Hilbert space with norm and inner product denoted by ∥•∥ and [symbol] •,• [symbol] , respectively. In some embodiments, X may be the space of images (e.g., “neural images”). For example, X may be R^{d}, L²(R), L²(R²). In some embodiments, G may be a compact (or locally compact) group and g may denote both a group element in G and its action/representation on X.

In some embodiments, normalized dot products of signals (e.g. images or “neural activities”) may be used. Such dot products may provide one or more invariances such as invariance to measurement units (e.g., in terms of both origin and scale). In some embodiments, dot products may be taken between functions or vectors that are zero-mean and of unit norm, so that [symbol] I,t [symbol] may set

$$I = \frac{{I}^{′} - {\overline{I}}^{′}}{‖ {I}^{′} - {\overline{I}}^{′} ‖} , t = \frac{{t}^{′} - {\overline{t}}^{′}}{‖ {t}^{′} - {\overline{t}}^{′} ‖}$$

with (•) the mean. This normalization stage before each dot product is consistent with the convention that the empty surround of an isolated image patch has zero value (which may be taken to be the average “grey” value over the ensemble of images). For example, the dot product of a template and the “empty” region outside an isolated image patch may be zero, and the dot product of two uncorrelated images (e.g., random 2D noise images) may also be approximately zero. However, it should be appreciated that aspects of the present disclosure are not limited to the use of a normalization stage.

Random Projections for Probability Distributions

The inventors have recognized and appreciated that in some embodiments, a finite number K of templates may be sufficient to obtain an approximation within a given precision ∈. Let

d_{μ}(μ^{k}(I),μ^{k}(I′))=∥μ^{k}(I)−μ^{k}(I)∥_{R}_{^{N,}} (3)

where ∥•∥_{R}_{^{N}} is the Euclidean norm in R^{N}. The inventors have recognized and appreciated the following for any n images Xₙ in X:

Let K be such that

$$K \geq \frac{c}{{ɛ}^{2}} log \frac{n}{δ} ,$$

where C is a universal constant. Then

|d(P_{I},P_{I′})−\hat{d}_{K}(P_{I},P_{I′})|≦∈, (4)

with probability 1−δ², for all I,I′∈Xₙ.

Memory Based Learning of Invariance

The inventors have recognized and appreciated that the signature Σ(I)=(μ₁¹(I), . . . , μ_{N}^{K}(I)) may be invariant and unique, since this signature is associated with an image and all of its transformations (e.g., an orbit). Each component of the signature may also be invariant, as each component may correspond to a group average. For example, each measurement may be written as

$${μ}_{n}^{k} ( I ) = \frac{1}{\vert G \vert} {\sum }_{g ∈ G} {η}_{n} ( 〈 gI , {t}^{k} 〉 ) , \qquad ( 5 )$$

for a finite group G, or

μₙ^{k}(I)=∫_{G}dgηₙ( [symbol] gI,t^{k} [symbol] )=∫_{G}dgηₙ( [symbol] I,g⁻¹t^{k} [symbol] ), (6)

when G is a compact (or locally compact) group. The non-linearity ηₙ may be chosen to define an histogram approximation. Then, the following may hold because of the properties of the Haar measure:

μₙ^{k}( g̅I)=μₙ^{k}(I), ∀ g̅∈G,I∈X. (7)

In some embodiments, the following steps may be performed to compute a signature μ(I), which may be invariant.
Given K templates {gt^{k}|∀g∈G}, k=1, . . . , K, compute [symbol] I,gt^{k} [symbol] the normalized dot products of the image with all the transformed templates (e.g., all g∈G although fewer than all transformations may also be used).
Pool the results: POOL({ [symbol] I,gt^{k} [symbol] |∀g∈G}).
Return μ(I), the pooled results for all k. As discussed above, μ(I) may be unique and invariant if there are enough templates.

Localization Condition: Translation and Scale

The inventors have recognized and appreciated that maximum translation invariance may imply a template with minimum support in the space domain (x), and maximum scale invariance may imply a template with minimum support in the Fourier domain (ω).

In some embodiments, invariants may be computed from pooling within a pooling window with a set of linear filters. Then optimal templates (e.g. filters) for maximum simultaneous invariance to translation and scale may be Gabor functions

$$t ( x ) = {e}^{\frac{{x}^{2}}{2 {σ}^{2}}} {e}^{i {ω}_{0} x} . \qquad ( 8 )$$

Approximate Invariance and Localization

The inventors have recognized and appreciated that the techniques described herein may be applied to non-group transformations. By relaxing the requirement of exact invariance and exact localization, representations that are invariant under non-group transformations may be obtained if certain localization properties of [symbol] TI,T [symbol] hold, where T is a smooth transformation.

For example, an approximate localization condition (e.g. for the 1D translations group) may be [symbol] I,Tₓt^{k} [symbol] <δ ∀x s.t|x|>a, where δ is small (e.g., in the order of 1/\sqrt{n}, where n is the dimension of the space) and [symbol] gI,t^{k} [symbol] ^{≈}1 ∀x s.t|x|<a. This property is referred to as sparsity of I in the dictionary t^{k} under G.

The inventors have recognized and appreciated that the sparsity condition above may be satisfied by templates that are similar to images in the set and are sufficiently “rich” to be incoherent for “small” transformations. Furthermore, the sparsity of I in t^{k} under G may improve with increasing n and with noise-like encoding of I and t^{k} by an architecture.

The inventors have further recognized and appreciated that the sparsity condition above may allow local approximate invariance to arbitrary transformations. In addition, the sparsity condition may provide clutter tolerance in the sense that if n₁, n₂ are additive uncorrelated spatial noisy clutter, then [symbol] I+n₁,gt^{k}+n₂ [symbol] ≈ [symbol] I,gt [symbol] .

The inventors have recognized and appreciated that the sparsity condition under a group may be related to associative memories (e.g., those of the holographic type). For example, if the sparsity condition holds only for I=t^{k} and for very small set of g∈G (e.g., where [symbol] I,gt^{k} [symbol] =δ(g)δ_{I,t}_{^{k}}), strict memory-based recognition may result (e.g., with no ability to generalize beyond stored templates or views).

As discussed above, a first regime using exact (or ∈−) invariance for generic images may yield universal Gabor templates, whereas a second regime using approximate invariance for a class of images (e.g., based on a sparsity condition) may yield class-specific templates. While the first regime may apply to the first layer of a hierarchy, the second regime may be used to deal with non-group transformations at the top levels of a hierarchy where receptive fields may be as large as the visual field.

Non-limiting examples of non-group transformations include the change of expression of a face, the change of pose of a body, etc. As discussed above, approximate invariance to transformations that are not groups may be obtained if the approximate localization condition above holds, and if the transformation can be locally approximated by a linear transformation, such as a combination of translations, rotations and non-homogeneous scalings, which may correspond to a locally compact group admitting a Haar measure.

Compact Groups

Some transformations, such as rotation in the image plane, form compact groups. The inventors have recognized and appreciated that a complex cell may be invariant for a compact group transformation when pooling over all the templates which span the full group (e.g., θ∈[−π,+π], without regard to the particular images that are used as templates. Any template may yield perfect invariance over the whole range of transformations (e.g., where some regularity conditions are satisfied). Furthermore, a single complex cell pooling over all templates may provide a globally invariant signature.

Locally Compact Groups and Partially Observable Compact Groups

For a partially observable group (POG) or locally compact group (LCG), pooling may be over a subset of the group. The inventors have recognized and appreciated that a complex cell may be partially invariant if the value of a dot-product between a template and its shifted template under the group falls to zero fast enough with the size of the shift relative to the extent of pooling. (This condition may be a special form of sparsity.) Partial invariance may hold for a POG (or LCG such as translations) over a restricted range of transformations if the templates and the inputs have a localization property that implies wavelets for transformations that include translation and scaling.

The inventors have recognized and appreciated that certain types of partial invariance may be useful for recognition. For example, simultaneous partial invariance to translations in x,y, scaling, and possibly rotation in the image plane may be useful. It may be desirable that this first type of partial invariance apply to “generic” images, and that the signatures preserve full, locally invariant information. Such a regime may be used, for example, for the first layers of a multilayer network, and may be related to Mallat's scattering transform. The inventors have recognized and appreciated some conditions under which this first type of invariance may be obtained. Non-limiting examples of such conditions include localization and the following self-localization condition on t: [symbol] gt,t [symbol] =0 g∉G_{L}⊂G.

As another example, partial invariance to linear transformations for a subset of all images may also be useful. This second type of partial invariance may apply to high-level modules in a multilayer network specialized for specific classes of objects and non-group transformations. The inventors have recognized and appreciated some conditions under which this second type of invariance may be obtained. Non-limiting examples of such conditions include sparsity of images with respect to a set of templates, which may apply only to a specific class of images I.

The inventors have further recognized and appreciated that for classes of images that are sparse with respect to a set of templates, the localization condition may not imply wavelets. Instead, the localization condition may imply templates that are
similar to a class of images so that [symbol] I,g₀t^{k} [symbol] ≈1 for some g₀ and
complex enough to be “noise-like” in the sense that [symbol] I,gt^{k} [symbol] ≈0 for g≠g₀.

The inventors have recognized and appreciated that, for approximate invariance to hold, it may be desirable to have templates that transform similarly to the input. Furthermore, for the localization property to hold, it may be desirable to have an image that is: (1) similar to a key template or contains a key template as a diagnostic feature (which may be a sparsity property), and (2) quasi-orthogonal under the action of the local group (and thus may be highly localized).

General (Non-Group) Transformations

Some transformations, although not groups, may be smooth. The inventors have recognized and appreciated that smoothness may imply that the transformation can be approximated by piecewise linear transformations, each centered around a template. For instance, the local linear operator may correspond to the first term of a Taylor series expansion around a chosen template.

The inventors have recognized and appreciated that if the dot-product between a template and its transformation falls to zero with increasing size of the transformation, and the templates transform as the input image, then a certain type of local invariance may be obtained. For instance, the transformation induced on the image plane by rotation in depth of a face may have piecewise linear approximations around a small number of key templates corresponding to a small number of rotations of a given template face (e.g., at ±30°,±90°,±120°, etc.). Each key template and its transformed templates within a range of rotations may correspond to complex cells (e.g., centered in ±30°,±90°,±120°, etc.). Each key template (e.g. complex cell) may correspond to a different signature which is invariant only for that part of rotation. There may be input images that are sparse with respect to templates of the same class, and for such images local invariance may hold.

Hierarchical Architectures

The inventors have recognized and appreciated that signatures may be generated with invariance, uniqueness and/or stability properties, both in the case when a whole group of transformations is observable, and in the case where the group is only partially observable. The inventors have further recognized and appreciated that a multi-layer architecture may be constructed having similar properties.

In some embodiments, signatures are provided for a finite group G. Given a subset G₀⊂G, a window gG₀ may be associated with each g∈G. Then, a signature Σ(I)(g) may be provided for each window given by the measurements,

$${μ}_{n}^{k} ( I ) ( g ) = \frac{1}{\vert {G}_{0} \vert} {\sum }_{\overline{g} ∈ g {G}_{0}} {η}_{n} ( 〈 I , \overline{g} {t}^{k} 〉 ) .$$

The inventors have recognized and appreciated that the average in the integral may be done for transformed templates, but not on transformed images. For fixed n,k, a set of measurements corresponding to different windows may be seen as a |G| dimensional vector. A signature Σ(I) for the whole image may then be obtained as a signature of signatures (e.g., a collection of signatures (Σ(I)(g₁), . . . , Σ(I)(g_{|G|}) associated respectively with the different windows).

In some embodiments, the output of each module may be made zero-mean and normalized before further processing at the next layer. The mean and the norm at the output of each module at each level of the hierarchy may be saved to allow conservation of information from one layer to the next.

Partial and Global Invariance (Whole and Parts)

The inventors have recognized and appreciated some conditions under which the functions μₗ may be locally invariant (e.g., invariant within the restricted range of the pooling). A non-limiting example of such a condition is the following:

Let I,t∈H a Hilbert space, η:R→R⁺ a bijective (positive) functions and G a locally compact group. Let Gₗ⊂G and suppose supp( [symbol] gμₗ₋₁(I),t [symbol] )⊂Gₗ. Then for any given g̅∈G

μₗ(I)=μₗ( g̅I) [symbol] gμₗ₋₁(I),t [symbol] =0,g∈G/(Gₗ∩ g̅Gₗ),

[symbol]

gμₗ₋₁(I),t [symbol] ≠0,g∈Gₗ∩ g̅Gₗ.

In some embodiments, an object part may be defined as the subset of the signal I whose complex response, at layer l, is invariant under transformations in the range of the pooling at that layer. The inventors have recognized and appreciated that the definition of object part may be consistent since the range of invariance may be increasing from layer to layer and therefore may allow bigger and bigger parts. Consequently, there may be a layer l̅ for each transformation such that any signal subset will be a part at that layer. The inventors have recognized and appreciated the following:

Let I∈X (an image or a subset of it) and μₗ the complex response at layer l. Let G₀⊂ . . . ⊂Gₗ⊂ . . . ⊂G_{L}=G be a set of nested subsets of the group G. Suppose η is a bijective (positive) function and that the template t and the complex response at each layer has finite support. Then ∀ g̅∈G, μₗ(I) is invariant for some l= l̅, i.e.

μₘ( g̅I)=μₘ(I),∃ l̅ s.t.∀m≧ l̅.

Approximate Factorization: Hierarchy

The inventors have recognized and appreciated that while factorization of invariance ranges is possible in a hierarchical architecture, factorization in successive layers of the computation of signatures invariant to a subgroup of the transformations (e.g. the subgroup of translations of the affine group) followed by invariance with respect to another subgroup (e.g., rotations) may not be possible. However, the inventors have recognized and appreciated that a transformation that can be linearized piecewise may be performed in higher layers, on top of other transformations, since a global group structure may not be required and weaker smoothness properties may be sufficient. Therefore, approximate factorization may be performed for transformations that are smooth.

Why Hierarchical Architectures?

The inventors have recognized and appreciated various benefits of hierarchical structures. For example, by using hierarchical structures, local connections may be optimized, and computational elements may be reused in an optimal way. Despite the high number of synapses on each neuron, a complex cell may not be able to pool information across all the simple cells needed to cover an entire image.

Furthermore, a hierarchical architecture may provide signatures of larger and larger patches of an image in terms of lower level signatures. As a result, a hierarchical architecture may be able to access memory in a way that matches naturally with the linguistic ability to describe a scene as a whole and as a hierarchy of parts.

Further still, in architectures such as the illustrative architecture shown in FIG. 7, approximate invariance to transformations specific for an object class may be learned and computed in different stages. This property may provide an advantage in terms of the sample complexity of multistage learning. For instance, approximate class-specific invariance to pose (e.g. for faces) may be computed on top of a translation-and-scale-invariant representation. Thus, the implementation of invariance may, in some cases, be “factorized” into different steps corresponding to different transformations.

Empirical Support

Several computational vision models (e.g., HMAX, trained convolutional networks, and the feedforward networks of N. Pinto et al.) include hierarchically stacked modules of simple and complex cells. However, only the most recent variants of HMAX incorporate invariances to complex transformations learned from video.

It was shown that pooling over stored views of template faces undergoing the transformation can be used to recognize new faces robustly to rotations in depth from a single example view. More recently, some of the techniques described herein are applied to unconstrained face recognition benchmarks: Labeled Faces in the Wild and PubFIG. 83. The resulting system is shown to perform comparably to the state of the art with considerably less engineering.

In prior versions of HMAX and some related models, rather than arbitrary invariances being learned from video, specific invariances to local translation (and sometimes scaling) were built in to the architecture. The inventors have recognized and appreciated that a model which learns to compute responses to the same set of templates at every position (and scale) by seeing videos of each template object translating (and scaling) through every position may perform just as well as a convolutional architecture that is specifically programmed to do so.

The best-performing version of HMAX for generic object categorization is an improved version of the Mutch-Lowe system. This improved version scores 74% on the Caltech 101 dataset, competitive with the state-of-the-art for a single feature type. The original version achieved a near-perfect score on the UIUC car dataset. Another HMAX variant added a time dimension for action recognition, outperforming both human annotators and a state-of-the-art commercial system on a mouse behavioral phenotyping task. An HMAX model was also shown to account for human performance in rapid scene categorization.

In convolutional architectures, random features perform nearly as well as features learned from objects. This includes models other than HMAX. For example, it was found that a convolutional network with randomized weights performed only 3% worse than the same network after training via back-propagation. Additionally, feature learning was found to be the least significant of several variables contributing to the performance of a hierarchical architecture.

Unsupervised Learning of the Template Orbit

The inventors have recognized and appreciated that the observation of the orbits of some templates may be done in an unsupervised way based on the temporal adjacency assumption. However, errors of temporal association may happen, such as when lights turn on and off, objects are occluded, the observer blinks his eyes, etc.

The inventors have recognized and appreciated that significant scrambling may be possible if the errors are not correlated. For example, normally an HW-module would pool all the [symbol] I,gᵢt^{k} [symbol] . In some situations, t^{k} may be replaced with a different template t^{k′} for some i. Empirical results show that even scrambling 50% of the connections in this manner only yields very small effects on performance Similar results are obtained on another non-uniform template orbit sampling experiment with 3D rotation-in-depth of faces.

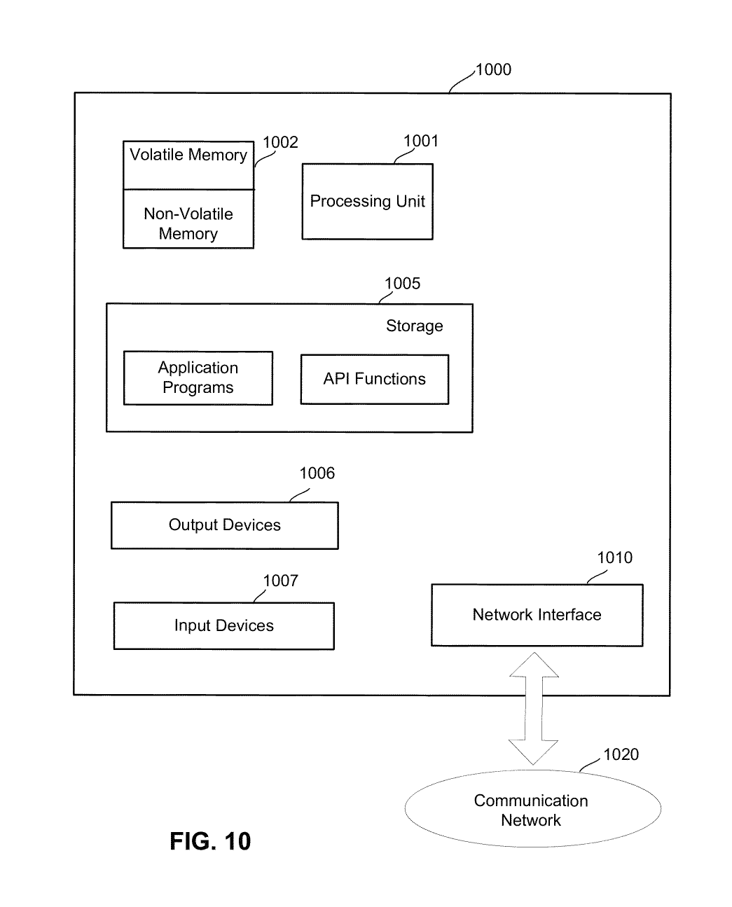

FIG. 10 shows, schematically, an illustrative computer system 1000 on which any aspect of the present disclosure may be implemented. For example, the computer system 1000 may be a mobile device on which any of the features described herein may be implemented. The computer system 1000 may also be used in implementing a server or some other component of a system in which any of the concepts described herein may be implemented. One or more computer systems such as the computer system 1000 may be used together to implement any of the functionality described above.

As used herein, a “mobile device” may be any computing device that is sufficiently small so that it may be carried by a user (e.g., held in a hand of the user). Examples of mobile devices include, but are not limited to, mobile phones, pagers, portable media players, e-book readers, handheld game consoles, personal digital assistants (PDAs) and tablet computers. In some instances, the weight of a mobile device may be at most one pound, one and a half pounds, or two pounds, and/or the largest dimension of a mobile device may be at most six inches, nine inches, or one foot. Additionally, a mobile device may include features that enable the user to use the device at diverse locations. For example, a mobile device may include a power storage (e.g., battery) so that it may be used for some duration without being plugged into a power outlet. As another example, a mobile device may include a wireless network interface configured to provide a network connection without being physically connected to a network connection point.

In the example shown in FIG. 10, the computer system 1000 includes a processing unit 1001 having one or more processors and a non-transitory computer-readable storage medium 1002 that may include, for example, volatile and/or non-volatile memory. The memory 1002 may store one or more instructions to program the processing unit 1001 to perform any of the functions described herein. The computer system 1000 may also include other types of non-transitory computer-readable medium, such as storage 1005 (e.g., one or more disk drives) in addition to the system memory 1002. The storage 1005 may also store one or more application programs and/or resources used by application programs (e.g., software libraries), which may be loaded into the memory 1002.

The computer system 1000 may have one or more input devices and/or output devices, such as devices 1006 and 1007 illustrated in FIG. 10. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 1007 may include a microphone for capturing audio signals, and the output devices 1006 may include a display screen for visually rendering, and/or a speaker for audibly rendering, recognized text.

As shown in FIG. 10, the computer 1000 may also comprise one or more network interfaces (e.g., the network interface 1010) to enable communication via various networks (e.g., the network 1020). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer readable medium or media can be transportable, such that the program or programs stored thereon can be loaded onto one or more different computers or other processors to implement various aspects of the present disclosure as discussed above.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A computer-implemented method for processing an input signal, the method comprising acts of:
combining an input pattern in the input signal with each stored representation of a plurality of stored representations of at least one template to obtain a respective value for each stored representation, thereby obtaining a plurality of values;
constructing a representation for the input pattern at least in part by analyzing a probability distribution associated with the plurality of values; and
providing the representation for the input pattern to a recognizer programmed to process the representation for the input pattern and output at least one label for the representation for the input pattern.

2. The computer-implemented method of claim 1, wherein the input signal comprises an image signal, and wherein the input pattern comprises an image of an object to be recognized.

3. The computer-implemented method of claim 2, wherein the object to be recognized comprises a face of a human.

4. The computer-implemented method of claim 2, wherein the at least one label for the input pattern comprises an identification of the object to be recognized.

5. The computer-implemented method of claim 2, wherein the at least one label for the input pattern comprises a category for the object to be recognized.

6. The computer-implemented method of claim 1, wherein the input signal comprises a speech signal, and wherein the input pattern comprises an utterance to be recognized.

7. The computer-implemented method of claim 1, wherein combining the input pattern with each of the plurality of stored representations comprises taking an inner product of the input pattern and the respective stored representation.

8. The computer-implemented method of claim 1, wherein the representation for the input pattern comprises a histogram of the plurality of values.

9. The computer-implemented method of claim 1, wherein constructing the representation for the input pattern comprises analyzing the plurality of values as samples drawn from a probability distribution.

10. The computer-implemented method of claim 9, wherein the representation for the input pattern comprises an n-th moment of the plurality of values as samples drawn from the probability distribution, and wherein n is finite and is greater than or equal to 2.

11. The computer-implemented method of claim 1, wherein the plurality of stored representations of the at least one template comprises a sequence of stored representations representing the at least one template undergoing a transformation.

12. The computer-implemented method of claim 11, wherein the input signal comprises an image signal and the at least one template comprises an image of an object, and wherein the transformation of the at least one template comprises a transformation selected from a set consisting of: translation, scaling and rotation in an image plane.

13. The computer-implemented method of claim 1, wherein:
the at least one template comprises K templates, t¹, t², . . . , t^{K};
the plurality of stored representations comprises, for each k from 1 to K, a respective plurality of stored representations of the template t^{k}; and
the plurality of values comprises, for each k from 1 to K, a respective plurality of values obtained, respectively, by combining the input pattern with each of the plurality of stored representations of the template t^{k}.

14. At least one computer-readable storage medium having encoded thereon instructions that, when executed by at least one processor, cause the at least one processor to perform a method for processing an input signal, the method comprising acts of:
combining an input pattern in the input signal with each stored representation of a plurality of stored representations of at least one template to obtain a respective value for each stored representation, thereby obtaining a plurality of values;
constructing a representation for the input pattern at least in part by analyzing a probability distribution associated with the plurality of values; and
providing the representation for the input pattern to a recognizer programmed to process the representation for the input pattern and output at least one label for the representation for the input pattern.

15. The at least one computer-readable storage medium of claim 14, wherein the input signal comprises an image signal, and wherein the input pattern comprises an image of an object to be recognized.

16. The at least one computer-readable storage medium of claim 15, wherein the object to be recognized comprises a face of a human.

17. The at least one computer-readable storage medium of claim 15, wherein the at least one label for the input pattern comprises an identification of the object to be recognized.

18. The at least one computer-readable storage medium of claim 15, wherein the at least one label for the input pattern comprises a category for the object to be recognized.

19. The at least one computer-readable storage medium of claim 14, wherein the input signal comprises a speech signal, and wherein the input pattern comprises an utterance to be recognized.

20. The at least one computer-readable storage medium of claim 14, wherein combining the input pattern with each of the plurality of stored representations comprises taking an inner product of the input pattern and the respective stored representation.

21. The at least one computer-readable storage medium of claim 14, wherein the representation for the input pattern comprises a histogram of the plurality of values.

22. The at least one computer-readable storage medium of claim 14, wherein constructing the representation for the input pattern comprises analyzing the plurality of values as samples drawn from a probability distribution.

23. The at least one computer-readable storage medium of claim 22, wherein the representation for the input pattern comprises an n-th moment of the plurality of values as samples drawn from the probability distribution, and wherein n is finite and is greater than or equal to 2.

24. The at least one computer-readable storage medium of claim 14, wherein the plurality of stored representations of the at least one template comprises a sequence of stored representations representing the at least one template undergoing a transformation.

25. The at least one computer-readable storage medium of claim 24, wherein the input signal comprises an image signal and the at least one template comprises an image of an object, and wherein the transformation of the at least one template comprises a transformation selected from a set consisting of: translation, scaling and rotation in an image plane.

26. The at least one computer-readable storage medium of claim 14, wherein:
the at least one template comprises K templates, t¹, t², . . . , t^{K};
the plurality of stored representations comprises, for each k from 1 to K, a respective plurality of stored representations of the template t^{k}; and
the plurality of values comprises, for each k from 1 to K, a respective plurality of values obtained, respectively, by combining the input pattern with each of the plurality of stored representations of the template t^{k}.

27. A system for processing an input signal, the system comprising at least one processor programmed by executable instructions to perform a method comprising acts of:
combining an input pattern in the input signal with each stored representation of a plurality of stored representations of at least one template to obtain a respective value for each stored representation, thereby obtaining a plurality of values;
constructing a representation for the input pattern at least in part by analyzing a probability distribution associated with the plurality of values; and
providing the representation for the input pattern to a recognizer programmed to process the representation for the input pattern and output at least one label for the representation for the input pattern.

28. The system of claim 27, wherein the input signal comprises an image signal, and wherein the input pattern comprises an image of an object to be recognized.

29. The system of claim 28, wherein the object to be recognized comprises a face of a human.

30. The system of claim 28, wherein the at least one label for the input pattern comprises an identification of the object to be recognized.

31. The system of claim 28, wherein the at least one label for the input pattern comprises a category for the object to be recognized.

32. The system of claim 27, wherein the input signal comprises a speech signal, and wherein the input pattern comprises an utterance to be recognized.

33. The system of claim 27, wherein combining the input pattern with each of the plurality of stored representations comprises taking an inner product of the input pattern and the respective stored representation.

34. The system of claim 27, wherein the representation for the input pattern comprises a histogram of the plurality of values.

35. The system of claim 27, wherein constructing the representation for the input pattern comprises analyzing the plurality of values as samples drawn from a probability distribution.

36. The system of claim 35, wherein the representation for the input pattern comprises an n-th moment of the plurality of values as samples drawn from the probability distribution, and wherein n is finite and is greater than or equal to 2.

37. The system of claim 27, wherein the plurality of stored representations of the at least one template comprises a sequence of stored representations representing the at least one template undergoing a transformation.

38. The system of claim 37, wherein the input signal comprises an image signal and the at least one template comprises an image of an object, and wherein the transformation of the at least one template comprises a transformation selected from a set consisting of: translation, scaling and rotation in an image plane.

39. The system of claim 27, wherein:
the at least one template comprises K templates, t¹, t², . . . , t^{K};
the plurality of stored representations comprises, for each k from 1 to K, a respective plurality of stored representations of the template t^{k}; and
the plurality of values comprises, for each k from 1 to K, a respective plurality of values obtained, respectively, by combining the input pattern with each of the plurality of stored representations of the template t^{k}.

40. A computer-implemented method for processing an input signal, the method comprising acts of:
combining an input pattern in the input signal with each stored representation of a plurality of stored representations of at least one template to obtain a respective value for each stored representation, thereby obtaining a plurality of values, wherein:
the plurality of stored representations of the at least one template comprises a sequence of stored representations representing the at least one template undergoing a transformation that is not translation or scaling;
constructing a representation for the input pattern based on the plurality of values; and
providing the representation for the input pattern to a recognizer programmed to process the representation for the input pattern and output at least one label for the representation for the input pattern.

41. The computer-implemented method of claim 40, wherein constructing a representation for the input pattern comprises analyzing a probability distribution associated with the plurality of values, and wherein the representation for the input pattern comprises a histogram of the plurality of values.

42. The computer-implemented method of claim 40, wherein constructing a representation for the input pattern comprises analyzing a probability distribution associated with the plurality of values, and wherein the representation for the input pattern comprises an n-th moment of the plurality of values as samples drawn from the probability distribution, and wherein n is finite and is greater than or equal to 2.

43. The computer-implemented method of claim 40, wherein constructing a representation for the input pattern comprises analyzing a probability distribution associated with the plurality of values, and wherein the representation for the input pattern comprises a linear combination of a plurality of moments of the plurality of values as samples drawn from the probability distribution.

44. The computer-implemented method of claim 40, wherein the transformation of the at least one template comprises a transformation selected from a set consisting of: rotation in depth, aging of a face, change in pose of a body, and change in expression of a face.

45. At least one computer-readable storage medium having encoded thereon instructions that, when executed by at least one processor, cause the at least one processor to perform a method for processing an input signal, the method comprising acts of:
combining an input pattern in the input signal with each stored representation of a plurality of stored representations of at least one template to obtain a respective value for each stored representation, thereby obtaining a plurality of values, wherein:
the plurality of stored representations of the at least one template comprises a sequence of stored representations representing the at least one template undergoing a transformation that is not translation or scaling;
constructing a representation for the input pattern based on the plurality of values; and
providing the representation for the input pattern to a recognizer programmed to process the representation for the input pattern and output at least one label for the representation for the input pattern.

46. The at least one computer-readable storage medium of claim 45, wherein constructing a representation for the input pattern comprises analyzing a probability distribution associated with the plurality of values, and wherein the representation for the input pattern comprises a histogram of the plurality of values.

47. The at least one computer-readable storage medium of claim 45, wherein constructing a representation for the input pattern comprises analyzing a probability distribution associated with the plurality of values, and wherein the representation for the input pattern comprises an n-th moment of the plurality of values as samples drawn from the probability distribution, and wherein n is finite and is greater than or equal to 2.

48. The at least one computer-readable storage medium of claim 45, wherein constructing a representation for the input pattern comprises analyzing a probability distribution associated with the plurality of values, and wherein the representation for the input pattern comprises a linear combination of a plurality of moments of the plurality of values as samples drawn from the probability distribution.

49. The at least one computer-readable storage medium of claim 45, wherein the transformation of the at least one template comprises a transformation selected from a set consisting of: rotation in depth, aging of a face, change in pose of a body, and change in expression of a face.

50. A system for processing an input signal, the system comprising at least one processor programmed by executable instructions to perform a method comprising acts of:
combining an input pattern in the input signal with each stored representation of a plurality of stored representations of at least one template to obtain a respective value for each stored representation, thereby obtaining a plurality of values, wherein:
the plurality of stored representations of the at least one template comprises a sequence of stored representations representing the at least one template undergoing a transformation that is not translation or scaling;
constructing a representation for the input pattern based on the plurality of values; and
providing the representation for the input pattern to a recognizer programmed to process the representation for the input pattern and output at least one label for the representation for the input pattern.

51. The system of claim 50, wherein constructing a representation for the input pattern comprises analyzing a probability distribution associated with the plurality of values, and wherein the representation for the input pattern comprises a histogram of the plurality of values.

52. The system of claim 50, wherein constructing a representation for the input pattern comprises analyzing a probability distribution associated with the plurality of values, and wherein the representation for the input pattern comprises an n-th moment of the plurality of values as samples drawn from the probability distribution, and wherein n is finite and is greater than or equal to 2.

53. The system of claim 50, wherein constructing a representation for the input pattern comprises analyzing a probability distribution associated with the plurality of values, and wherein the representation for the input pattern comprises a linear combination of a plurality of moments of the plurality of values as samples drawn from the probability distribution.

54. The system of claim 50, wherein the transformation of the at least one template comprises a transformation selected from a set consisting of: rotation in depth, aging of a face, change in pose of a body, and change in expression of a face.
